(19) United States
(12) Patent Application Publication
(10) Pub. No.: US 2019/0251130 A1
(43) Pub. Date: Aug. 15, 2019

(54) METHOD AND APPARATUS FOR DETECTING PAGE REDIRECTION CIRCULATION

(71) Applicant: ALIBABA GROUP HOLDING LIMITED, GRAND CAYMAN (KY)

(72) Inventor: Ziqiang CHEN, HANGZHOU (CN)

(21) Appl. No.: 16/391,779

(22) Filed: Apr. 23, 2019

Related U.S. Application Data
(63) Continuation of application No. PCT/CN2017/106539, filed on Oct. 17, 2017.

(30) Foreign Application Priority Data
Oct. 24, 2016 (CN) 201610949251.3

(51) Int. Cl. G06F 16/954; G06F 16/955

(52) U.S. Cl. CPC G06F 16/954; G06F 16/955

(57) ABSTRACT

A method, an apparatus, and a non-transitory computer-readable storage medium for detecting a page redirect loop are provided. The method comprises: acquiring a sequence of times at which a target page is accessed, the target page being a node page in a page redirect chain; determining whether the target page is accessed periodically based on the sequence of times; and in response to determining that the target page is accessed periodically, determining that a page redirect loop occurs in the page redirect chain.

### CROSS-REFERENCE TO RELATED APPLICATIONS

This application is a continuation application of International Patent Application No. PCT/CN2017/106539, filed on Oct. 17, 2017, which is based on and claims priority to the Chinese Patent Application No. 201610949251.3, filed on Oct. 24, 2016 and entitled “Method and Apparatus for Detecting Page Redirect Loop.” The above-referenced applications are incorporated herein by reference in their entirety.

### TECHNICAL FIELD

The present application relates to computer technologies, and in particular, to a method and an apparatus for detecting a page redirect loop.

### BACKGROUND

To display a page, page redirect sometimes is performed due to various reasons. For example, when a transaction page is being rendered, if it is detected that a user has not logged in or the user's login has expired, the access to the transaction page can be redirected to a login page. After the user's login succeeds, the access is redirected to the transaction page. In the page redirect process, a redirect chain may be formed and include multiple pages transitioning from one to another, such as A→B→C, which indicates that the access to a page A is redirected to a page B, and then redirected to a page C. However, a page redirect loop, such as A→B→C→A→B→C . . . , may occur due to a processing error on a node page of the redirect chain, such as any one of the pages A, B, and C. This results in a great pressure on the backend of each page and a waste of processing resources. Therefore, it is very important to quickly and effectively detect a page redirect loop, so as to take measures to fix it timely.

An existing method can be used to detect whether a cycle exists in a redirect chain, and determine that a page redirect loop occurs if a cycle exists. However, this method requires acquisition of complete information of the redirect chain. When the chain is relatively long, a large amount of processing resources is consumed to acquire the information. Moreover, it is sometimes impossible to acquire complete information of a redirect chain. For example, in a scenario of cross-site trusted login, a redirect chain may include sites belonging to different owners, making it difficult to acquire information of the chain, thereby restricting applications of the existing method.

### SUMMARY

The present specification provides a method, an apparatus, and a non-transitory computer-readable storage medium for detecting a page redirect loop, enabling the detection of a page redirect loop to be simpler and more widely applied.

According to a first aspect, the method for detecting a page redirect loop may include acquiring a sequence of times at which a target page is accessed. The target page may be a node page in a page redirect chain. The method may further include determining whether the target page is accessed periodically based on the sequence of times, and in response to determining that the target page is accessed periodically, determining that a page redirect loop occurs in the page redirect chain.

In some embodiments, the sequence of times may include: times at which a same user accesses the target page. In other embodiments, the sequence of times may include: times at which a same device accesses the target page.

In still other embodiments, determining whether the target page is accessed periodically based on the sequence of times may include: analyzing the sequence of times by using one of a spectrum analysis based Fourier analysis, a periodogram detection method, or a maximum entropy detection method, to determine whether the sequence of times is periodic.

In yet other embodiments, the target page may include one or more of a Personal Computer (PC) page, an HTML5 (h5) page, and a native page. In other embodiments, the target page may include a page having a non-Uniform Resource Locator (URL) identifier.

In still other embodiments, after determining that a page redirect loop occurs in the page redirect chain, the method may further include sending loop alarm information.

According to a second aspect, the apparatus for detecting a page redirect loop may include one or more processors and one or more computer-readable memories coupled to the one or more processors and configured with instructions. The instructions may be executable by the one or more processors to cause the apparatus to perform operations including: acquiring a sequence of times at which a target page is accessed, the target page being a node page in a page redirect chain; determining whether the target page is accessed periodically based on the sequence of times; and in response to determining that the target page is accessed periodically, determining that a page redirect loop occurs in the page redirect chain.

According to a third aspect, the non-transitory computer-readable storage medium may be configured with instructions. The instructions may be executable by one or more processors to cause the one or more processors to perform operations including: acquiring a sequence of times at which a target page is accessed, the target page being a node page in a page redirect chain; determining whether the target page is accessed periodically based on the sequence of times; and in response to determining that the target page is accessed periodically, determining that a page redirect loop occurs in the page redirect chain.

With the method, the apparatus, and the non-transitory computer-readable storage medium for detecting a page redirect loop according to the present specification, the occurrence of a redirect loop can be determined by monitoring a single node page in a redirect chain and analyzing the sequence of access times at which the single page is accessed. This method may not require the entire redirect chain, and therefore is relatively simple to implement and also reduces consumption of system resources. Moreover, even in a cross-site page redirect scenario, since a loop can be determined by monitoring a single page, the method can be more widely applied.

### BRIEF DESCRIPTION OF THE DRAWINGS

FIG. 1 is a flow chart of a method for detecting a page redirect loop according to some embodiments of the present specification;

FIG. 2 is a schematic structural diagram of an apparatus for detecting a page redirect loop according to some embodiments of the present specification;

FIG. 3 is a schematic structural diagram of another apparatus for detecting a page redirect loop according to some embodiments of the present specification.

### DETAILED DESCRIPTION

A page redirect loop may occur when, during a process of displaying page-type resources, a cycle appears in a redirect chain due to various reasons. For example, in a redirect chain, such as A→B→C— . . . A→B→C, where A, B, C represents a page A, a page B, and a page C respectively, transition is repeated among the page A, page B, and page C, causing a great pressure on the backend of each page.

In some embodiments, features of page redirect loops are used as the basis for detecting and identifying the occurrence of a page redirect loop. Still taking the above-described chain “A→B→C— . . . A→B→C” having a page redirect loop as an example, in the circular redirect among the pages, one node page of the pages, such as the page A, page B, or page C, may be accessed repeatedly. For example, taking the page B as an example, after the page B is first accessed, it may be accessed again after a short time, and again after another short time. The times when the page B is accessed may be recorded, and a sequence of access times may thus be formed, such as “t1, t2, t3, . . . .”

Moreover, another feature is that the page redirect loop in a redirect chain is fixed. In the above example, the circular redirect always happens among the page A, page B, and page C. Therefore, as time goes on, the page B may be accessed repeatedly always at a relatively fixed interval. For example, the page B is accessed periodically and the access times may be periodic.

Based on the above features of a page redirect loop, the embodiments of the present specification provide a method for detecting a page redirect loop. The method can determine the occurrence of the page redirect loop by monitoring one node page of the transition chain of the page redirect loop. Taking the above-described circular redirect from the page A to the page C “A→B→C— . . . A→B→C” as an example, any one of the page A, page B, and page C can be monitored.

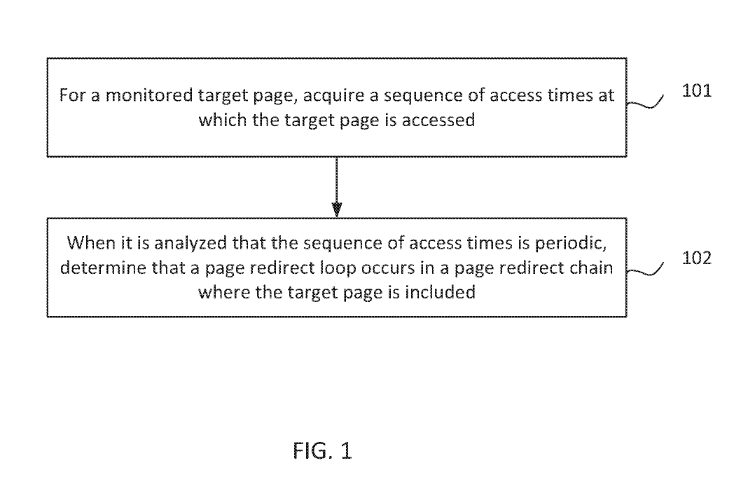

FIG. 1 is a flow chart of a method for detecting a page redirect loop. The method can include the following steps 101 and 102.

Step 101, for a monitored target page, acquiring a sequence of access times at which the target page is accessed, the target page being one node page in a page redirect chain.

A monitoring system may be used to implement the monitoring. When a page is to be monitored, the to-be-monitored page can be added as a monitored object of the monitoring system. For example, in a redirect chain, some of the pages of the chain may experience exception, leading to the occurrence of a redirect loop. This can be determined through a pre-analysis. For example, in a potential redirect loop, what pages may be accessed in a circular manner can be pre-analyzed. For example, still taking the above-described redirect chain “A→B→C— . . . A→B→C” as an example, if a page redirect loop occurs, it is very likely that the page B in the redirect loop may be accessed in a circular manner. The monitoring system can be set to initiate monitoring on the page B, and the page B can be referred to as a monitored target page. The target page selected in the example is a node page of the page redirect chain.

In this step 101, during the page transition in a redirect loop, the page B may be accessed repeatedly at an time interval. The monitoring system can obtain a sequence of times of accesses to the page B. For example, the sequence can be t1, t2, t3, . . . , tn, indicating that the page B is accessed at the moment of t1, again at the moment of t2, once more at the moment of t3, and so on. The sequence of the times of accesses to the page B can be, for example, obtained by the monitoring system from a page access log recorded at the backend of the page B.

Step 102, when it is analyzed that the sequence of access times is periodic, determining that a page redirect loop occurs in the page redirect chain where the target page is included.

In the above example, the monitoring system can analyze the sequence of access times “t1, t2, t3, . . . , tn” obtained in the step 101 to determine whether the access times in the sequence are periodic. For example, assuming that the interval between t1 and t2 is 2 seconds, one ideal situation is that the interval between t2 and t3 is also 2 seconds, so is the interval between t3 and t4, and so on. In other words, the page B is accessed at a fixed interval of 2 seconds, and thus it can be determined that the sequence of access times is periodic.

In other examples, the above-described intervals between the access times in the sequence may be different. Still assuming that the interval between t1 and t2 is 2 seconds, the interval between t2 and t3 may be 1.8 seconds, the interval between t3 and t4 may be 2.1 seconds, etc. The sequence of access times may be “2, 1.8, 2.1, 2.2, 1.9, . . . .” While the intervals among the access times fluctuate within a range, overall, the intervals are stable around a fixed value, such as 2. Therefore, in this example, the sequence of access times can also be regarded to be periodic.

A number of methods for monitoring periodicity of time sequences can be used, e.g., including, but not limited to, a spectrum analysis based Fourier analysis, a periodogram based detection method, a maximum entropy based detection method, etc., to identify whether a time sequence is periodic and to determine the occurrence of a loop with a level of confidence and an accuracy.

In some embodiments, in the process of detecting the periodicity of a time sequence, a period length of the time sequence can be determined. For example, some possible period lengths can be preset and referred to as candidate period values; a level of confidence and a period threshold value can be set for period lengths, and the level of confidence for the candidate period values can be greater than or equal to a given period threshold value. The period's confidence for a time sequence indicates the number of times in a row that a pattern appears before the time sequence can be regarded as periodic. A periodic time sequence may allow some noises to exist therein, but the noises cannot appear more than a number of times. If the noises occur in the time sequence more than a number of times, the periodicity may no longer exist in the time sequence.

In the above example, the page B is one node page in the page redirect chain. When the sequence of access times of the page B is determined to be periodic, it can be determined that a page redirect loop occurs in the redirect chain where the page B is included.

After the monitoring system determines the occurrence of a page redirect loop, the monitoring system can take measures to warn against the occurrence of the redirect loop and can send information such as a redirect loop alarm. For example, the redirect loop alarm can include a text message or email notice sent to relevant technical personnel, so that the technical personnel decides on corresponding subsequent processing measures. Alternatively, the monitoring system can determine that, when the occurrence of the redirect loop is detected, new access requests are to be rejected. For example, an agent module can be provided in a transaction system to which the page belongs, and the agent module can receive requests to access the page and perform corresponding processing. When the monitoring system determines, by using the detection method according to the present specification, that a page redirect loop occurs in the redirect chain where the page is included, alarm information with respect to the loop can be sent to the agent module so as to notify the agent module, and the agent module may reject an access to the page when the agent module receives a request to access the page afterward.

In the detection method according to the embodiments of the present specification, the occurrence of a redirect loop can be determined by monitoring a single node page in a redirect chain and analyzing the sequence of access times of the single page. Since this method may not require the entire redirect chain, it is relatively simple to be implemented and may also reduce the consumption of system resources. Moreover, even in a cross-site page redirect scenario, since a loop can be determined by monitoring a single page, the method can be more widely applied.

In some embodiments, the sequence of access times of a target page obtained by the monitoring system can be recorded in a user dimension or in a device dimension. For example, the sequence of access times can be a sequence of the access times at which the same user accesses the target page, such as the page B in the above examples; alternatively, the sequence of access times can be a sequence of access times at which the same device accesses the target page, such as the page B in the above examples.

For example, a user goes online on his/her personal computer and visits some websites. A page redirect loop occurs during the visit process. The redirect loop can be “g1-g2-g3-g1-g2-g3 . . . .” A backend access log corresponding to one page may record access information of the page. The access information of the page can include a variety of information, such as an account number of a user accessing the page (e.g., when a user logs in an account registered with a website and then accesses a page of the website, account information of the user accessing the page can be recorded in the log), an identifier of a device used by a user to access the page (e.g., a unique hardware identifier of a computer used by the user), an access time when the page is accessed, and the like. When the redirect loop occurs, one node page can be repeatedly accessed, and the above-described access information can be recorded at each access.

In some other embodiments, the sequence of access times can include access times recorded in other dimensions. In some embodiments, what information to be recorded can be flexibly set. For example, in the recording manner based on a user dimension, identifiers of devices accessing the page may not be recorded; instead, the times are recorded when a user accesses the page. This way, when the sequence of the access times of the page is to be obtained subsequently, the access times corresponding to the same user's identifier can be found based on the user's identifier, and therefore the sequence of the access times can be obtained. In another example, records can be made based on an device dimension, in which manner identifiers of users accessing the page may not be recorded; instead, the times are recorded when a device accesses the page. This way, when the sequence of access times of the page is to be obtained subsequently, the access times corresponding to the same device's identifier can be found based on the device's identifier, and therefore the sequence of the access times can be obtained. In still another example, users and devices accessing the page can be both recorded in the access information, while a sequence of access times can be obtained from a log by using a search based on a user dimension or a search based on a device dimension.

In addition, a variety of pages may experience a page redirect loop in the embodiments of the present specification, such as Personal Computer (PC) pages identified by a Uniform Resource Locator (URL) (i.e., pages having URL addresses), HTML5 (h5) pages, or native pages; alternatively, the pages can be page resources having non-URL identifiers.

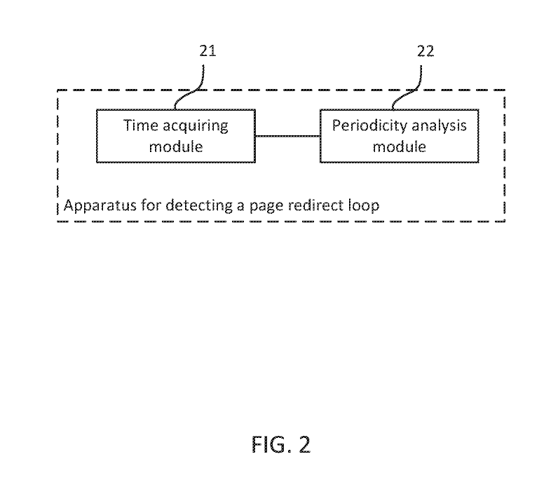

The embodiments of the present specification further provide an apparatus for detecting a page redirect loop. As shown in FIG. 2, the apparatus can include: a time acquiring module 21 and a periodicity analysis module 22. The time acquiring module 21 may be configured to, for a monitored target page, acquire a sequence of access times at which the target page is accessed, the target page being one node page in a page redirect chain; and the periodicity analysis module 22 may be configured to, when it is analyzed that the access time sequence is periodic, determine that a page redirect loop occurs in the page redirect chain where the target page is included.

In some embodiments, the sequence of access times may include the access times at which the same user accesses the target page; alternatively, the sequence of access times may include the access times at which the same device accesses the target page.

In some embodiments, the periodicity analysis module 22 may be configured to use a detection method, such as a spectrum analysis-based Fourier analysis, a periodogram based detection method, or a maximum entropy based detection method, to analyze whether the sequence of access times is periodic and to determine that the sequence of access times is periodic. In some embodiments, the target page may include a PC page, an h5 page, or a native page.

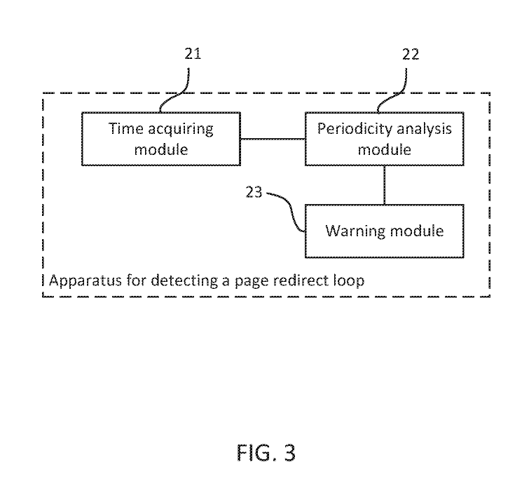

In some embodiments, as shown in FIG. 3, the apparatus can further include: a warning module 23 configured to send loop alarm information after the periodicity analysis module 22 determines that a page redirect loop occurs in the page redirect chain where the target page is included.

Embodiments are described with reference to the flow charts and/or block diagrams of the method, device, apparatus, system, and/or non-transitory computer-readable storage medium according to the application. It should be understood that every process and/or block of the flow charts and/or block diagrams and a combination of processes and/or blocks of the flow charts and/or block diagrams can be implemented by computer program instructions. These computer program instructions can be provided to a general-purpose computer, a dedicated computer, an embedded processor, or a processor of another programmable data processing device, thereby producing a machine and causing the instructions to be executable by the computer or the processor of another programmable data processing device, to produce an apparatus for implementing functions specified in one or more processes in the flow charts and/or one or more blocks in the block diagrams.

These computer program instructions can also be stored in a computer readable storage medium capable of guiding a computer or other programmable data processing devices to work in a particular manner, causing the instructions stored in the computer readable storage medium to produce a manufactured article that includes an instruction device for implementing functions specified in one or more processes in the flow charts and/or one or more blocks in the block diagrams.

These computer program instructions can also be loaded onto a computer or other programmable data processing devices, causing a series of operation steps to be executable by the computer or other programmable data processing devices to produce a process of computer implementation. As a result, the instructions executable by the computer or other programmable data processing devices provide steps to implement functions specified in one or more processes in the flow charts and/or one or more blocks in the block diagrams.

In a typical configuration, a computation device includes one or more processors (CPUs), input/output interfaces, network interfaces, and a memory. The memory may include computer readable media, such as a volatile memory, a Random Access Memory (RAM), and/or a non-volatile memory, e.g., a Read-Only Memory (ROM) or a flash RAM. The memory is an example of a computer readable medium.

Computer readable media include permanent, volatile, mobile and immobile media, which can implement information storage through any method or technology. The information may be computer readable instructions, data structures, program modules or other data. Examples of storage media of computers include, but are not limited to, Phase-change RAMs (PRAMs), Static RAMs (SRAMs), Dynamic RAMs (DRAMs), other types of Random Access Memories (RAMs), Read-Only Memories (ROMs), Electrically Erasable Programmable Read-Only Memories (EEPROMs), flash memories or other memory technologies, Compact Disk Read-Only Memories (CD-ROMs), Digital Versatile Discs (DVDs) or other optical memories, cassettes, cassette and disk memories or other magnetic memory devices or any other non-transmission media, which can be used for storing information accessible to a computation device. According to the definitions herein, the computer readable media do not include transitory media, such as modulated data signals and carriers.

It should be further noted that the terms of “including,” “comprising” or any other variants thereof intend to encompass a non-exclusive inclusion, causing a process, method, commodity or device comprising a series of elements to not only comprise these elements, but also comprise other elements that are not specifically listed, or further comprise elements that are inherent to the process, method, commodity or device. When there is no further restriction, elements defined by the statement “including one . . . ” do not exclude that a process, method, commodity or device comprising the above elements further comprises additional identical elements.

This application may be implemented as a complete hardware embodiment, a complete software embodiment, or an embodiment combing software and hardware. Moreover, this application may be in the form of a computer program product implemented on one or more computer usable storage media (including, but not limited to, a magnetic disk memory, CD-ROM, an optical memory, and the like) comprising computer usable program codes therein.

The above-described is merely embodiments of the application, which are not used to limit the application. Any modification, equivalent substitution or improvement made within the spirit and principle of the application shall be encompassed by the protection scope of the application.

What is claimed is:

1. A computer-implemented method for detecting a page redirect loop, comprising:
acquiring a sequence of times at which a target page is accessed, the target page being a node page in a page redirect chain;
determining whether the target page is accessed periodically based on the sequence of times; and
in response to determining that the target page is accessed periodically, determining that a page redirect loop occurs in the page redirect chain.

2. The method according to claim 1, wherein the sequence of times comprises: times at which a same user accesses the target page.

3. The method according to claim 1, wherein the sequence of times comprises: times at which a same device accesses the target page.

4. The method according to claim 1, wherein determining whether the target page is accessed periodically based on the sequence of times comprises:
analyzing the sequence of times by using one of a spectrum analysis based Fourier analysis, a periodogram detection method, or a maximum entropy detection method, to determine whether the sequence of times is periodic.

5. The method according to claim 1, wherein the target page includes one or more of a Personal Computer (PC) page, an HTML5 (h5) page, and a native page.

6. The method according to claim 1, wherein the target page includes a page having a non-Uniform Resource Locator (URL) identifier.

7. The method according to claim 1, wherein, after determining that a page redirect loop occurs in the page redirect chain, the method further comprises: sending loop alarm information.

8. An apparatus for detecting a page redirect loop, comprising: one or more processors and one or more computer-readable memories coupled to the one or more processors and configured with instructions executable by the one or more processors to cause the apparatus to perform operations comprising:
acquiring a sequence of times at which a target page is accessed, the target page being a node page in a page redirect chain;
determining whether the target page is accessed periodically based on the sequence of times; and
in response to determining that the target page is accessed periodically, determining that a page redirect loop occurs in the page redirect chain.

9. The apparatus according to claim 8, wherein the sequence of times comprises: times at which a same user accesses the target page.

10. The apparatus according to claim 8, wherein the sequence of times comprises: times at which a same device accesses the target page.

11. The apparatus according to claim 8, wherein determining whether the target page is accessed periodically based on the sequence of times comprises:
analyzing the sequence of times by using one of a spectrum analysis based Fourier analysis, a periodogram detection method, or a maximum entropy detection method, to determine whether the sequence of times is periodic.

12. The apparatus according to claim 8, wherein the target page includes one or more of a Personal Computer (PC) page, an HTML5 (h5) page, and a native page.

13. The apparatus according to claim 8, wherein the target page includes a page having a non-Uniform Resource Locator (URL) identifier.

14. The apparatus according to claim 8, wherein, after determining that a page redirect loop occurs in the page redirect chain, the operations further comprise: sending loop alarm information.

15. A non-transitory computer-readable storage medium configured with instructions executable by one or more processors to cause the one or more processors to perform operations comprising:
acquiring a sequence of times at which a target page is accessed, the target page being a node page in a page redirect chain;
determining whether the target page is accessed periodically based on the sequence of times; and
in response to determining that the target page is accessed periodically, determining that a page redirect loop occurs in the page redirect chain.

16. The non-transitory computer-readable storage medium according to claim 15, wherein the sequence of times comprises: times at which a same user accesses the target page.

17. The non-transitory computer-readable storage medium according to claim 15, wherein the sequence of times comprises: times at which a same device accesses the target page.

18. The non-transitory computer-readable storage medium according to claim 15, wherein determining whether the target page is accessed periodically based on the sequence of times comprises:
analyzing the sequence of times by using one of a spectrum analysis based Fourier analysis, a periodogram detection method, or a maximum entropy detection method, to determine whether the sequence of times is periodic.

19. The non-transitory computer-readable storage medium according to claim 15, wherein the target page includes one or more of a Personal Computer (PC) page, an HTML5 (h5) page, and a native page.

20. The non-transitory computer-readable storage medium according to claim 15, wherein, after determining that a page redirect loop occurs in the page redirect chain, the operations further comprise: sending loop alarm information.
